(19) United States
(12) Patent Application Publication
(10) Pub. No.: US 2010/0176169 A1
(43) Pub. Date: Jul. 15, 2010

(54) System and Method for Attaching Containers to a Trunk Surface

(76) Inventor: Terry Lovett, Newport Beach, CA (US)

Correspondence Address: PATENTMETRIX, 14252 CULVER DR. BOX 914, IRVINE, CA, 92604, US

(21) Appl. No.: 12/409,312

(22) Filed: Mar. 23, 2009

Related U.S. Application Data
(63) Continuation of application No. 61/144,109, filed on Jan. 12, 2009.

(51) Int. Cl. B62J 7/00; B60R 9/00

(52) U.S. Cl. 224/413; 224/555

(57) ABSTRACT

The present invention is directed to a container system, and a container attachment system, for attaching at least one container to the surface of a trunk lid. The attachment, or fastening, system includes a trunk bra that has flap edging comprising a mechanism for attaching to the interior of the trunk and buckles for attaching to straps on the container.

### CROSS-REFERENCE

The present invention relies on U.S. Provisional Application No. 61/144,109 filed on Jan. 12, 2009 for priority and is incorporated herein by reference.

### FIELD OF THE INVENTION

The present invention relates generally to the field of vehicle accessories, and, more specifically, to a fastening system that allows luggage to be securely fastened to the smooth, contoured surface of a trunk.

### BACKGROUND OF THE INVENTION

Motorcycles typically have a nominal trunk incorporated into the structure of the motorcycle itself. Design Pat. No. D244927, which is incorporated herein by reference, is an example of a typical motorcycle trunk, which is used to accommodate luggage during riding.

There are limitations, however, to the amount of luggage which can be included in a typical motorcycle trunk. Specifically, most trunks are limited in size and unable to accommodate an extensive amount of luggage. Accordingly, motorcycle riders, or bikers, are faced with the challenge of how best to carry luggage that cannot be accommodated in the trunk.

Some individuals address that problem by attaching a rack on the motorcycle trunk surface. With a rack on the motorcycle, additional pieces of luggage can simply be fastened, using rope or cables, to the rack. This approach, while feasible, has certain disadvantages. Foremost among the disadvantages is the fact that the motorcycle has a rack permanently affixed, even when an individual does not need to carry additional luggage. For many, the permanent addition of a rack negatively affects the aesthetic look and feel of the motorcycle. While racks can, in theory, be removed, they leave scratches and holes that, again, negatively affect the aesthetic look and feel of the motorcycle.

Prior art methods and systems do not adequately solve the problem of aesthetically and securely attaching additional luggage to a trunk top. Specifically, United States Patent Publication No. 20070235486 by Tim Bernard discloses “[a] storage container for personal items, tools, gear, and the like, that can be mounted to a motorcycle or other recreational vehicle. A lid fits to the top of the container and is attached to the containment body with slide-hinges on either end of one side of the containment body. The lid is able to raise vertically above the containment body for the distance allowed by the bolt and slide-hinge arrangement, then pivot over to one side of the containment body, for ease in packing and retrieving objects inside the box. The lid can be latched tightly over the containment body by way of locks at each end. The lid rests against a rubber sealing ring around the opening of the containment body to provide a tight seal for protecting the contents inside the box against elements. In its fully open state, the lid can support small items.”

U.S. Pat. No. 6,123,239, granted to Lovett describes “[a] travel bag for a motorcycle is disclosed that can be easily attached and removed from a variety of different size motorcycle seat backs or sissy bars and ensures that the bag is secure during motorcycle operation. The bag carries a series of vertically aligned straps on the exterior surface of the bag that faces the front of the motorcycle. Each strap is adjustable in length to fit a variety of seat back widths. The height of the seat back or sissy bar determines how many straps are used. The straps are located on the bag so that the bottom of the bag may rest on the luggage rack when the bag is appropriately affixed to the seat back. Additional straps fasten the bag down to the luggage rack or the seat back itself, to prevent the bag from being lifted off at high speeds.”

United States Patent Publication Number 20040040993 by Daryl Eric Spratley describes “[an] arrangement for securing a commercially available hydration pack to a motorcycle which provides for easy access to the fluid in the hydration pack by the motorcycle rider. The hydration pack maintains its original functionality, yet is quickly attached to the motorcycle fuel tank top planar area in front of the rider with use of quick connect fastener elements and nylon web strapping materials. This system of attachment straps and connectable fasteners along with methods for attaching these straps and fasteners to a hydration pack and a motorcycle result in the hydration pack being securely, yet removably mounted to the motorcycle fuel tank area.”

United States Patent Publication No. 20060043131 by Steven Lee Graham discloses “[a] storage container for a straddle-type motor vehicle is described that comprises a top providing a seating area. A plurality of sides extend from the top and define a storage compartment. The storage compartment is longer than it is wide and oriented longitudinally along the vehicle parallel to the direction of travel. The storage container is open at the rear of the vehicle to provide access to the storage compartment without moving the seating area.”

United States Patent Publication No. 20030066854 by Edgar Heinrich, et al describes “[a] trunk system which is intended for motorcycles and which, together with a luggage rack disposed in the rear area of the motorcycle, forms a plane. The result is an expanded, stable supporting surface for additional luggage.”

U.S. Pat. No. 3,788,532, granted to Bish, discloses “a saddlebag-travel case device for mounting on the rear portion of a motorcycle, comprising a unitary, lower baggage container unit which is adapted to be fixedly attached to the frame of the motorcycle, said lower container unit surrounding the sides and rear of the motorcycle in wrap-around fashion. The rear of the lower container unit may be provided with tail lights and other traffic safety equipment. A unitary upper container unit is provided and it is detachably secured to the top of the lower container unit. The upper and lower container units are provided with latching and locking means and may be independently opened or locked when the upper container unit is in place or when said upper container has been detached.” Also see U.S. Pat. No. 3,393,845.

While the aforementioned patents, all of which are incorporated by reference, disclose forms of attaching, or using, luggage with a vehicle, they fail to disclose methods and systems for attaching luggage to the trunk of a vehicle where the trunk surface is smooth or rackless, devoid of protusions for hooking or fastening luggage and for attaching the luggage in a manner that is highly stable, secure, and able to withstand substantial force being exerted by air pressure or the movement of the vehicle itself.

Thus, there is need in the prior art for a system and method to attach additional piece(s) of luggage to a rackless, smooth, or protusion-less trunk top. Preferably, the system and method should not detract from the overall aesthetic sense of the motorcycle and yet serve to securely attaching additional luggage.

### SUMMARY OF THE INVENTION

It is an object of the present invention to attach additional pieces of luggage to a rackless, smooth, or protusion-less trunk top.

Accordingly, in one embodiment, a fastening system of the present invention is securely attached to the top surface of the trunk and the additional piece of luggage is then fastened onto the fastening system, and therefore to the trunk top. In one embodiment, the fastening system is a trunk bra that has flap edging comprising Velcro loops. The inner edges of the trunk top comprise Velcro hook strips. The flap edging passes around and is folded under to the underside of the trunk top and are secured to corresponding hook strips thereby firmly attaching the bra to the trunk top. When the trunk top is closed the flap edging is pressed by the closed trunk top thereby further reinforcing the bra to stay on the trunk top. The bra also comprises at least one fastener on the top edges. In one embodiment, the bra comprises a plurality of fasteners on the top edge. In one embodiment, at least one fastener is a buckle or D-ring. It should be noted herein that any type of fastener may be used, as is described in detail below.

In another embodiment of the present invention, a container is used as additional luggage to be attached to the trunk top by means of the trunk bra. The container, in one embodiment, comprises Velcro straps that pass through the bra D-rings/buckles for securely tying down the container and fastening it to the bra.

In one embodiment, the container bottom is contoured to conform to the curvature of the underlying trunk top to minimize any air gap between the trunk bra and the container for secure attachment.

In one embodiment, the container has length and breadth that are less than the corresponding dimensions of the trunk bra such that no portion of the container bottom protrudes over or overlaps the bra and/or seam and thus, the trunk area. In addition, this ensures convenient use of the fasteners or D-rings for uniform attachment.

In another embodiment, the container has length and breadth that are less than, equal to, or greater than the corresponding dimensions of a rack mounted on trunk top. This allows the container to be conveniently attached to rack railings using Velcro straps. It should be noted herein that the dimensions provided are only exemplary and that any size container can be used so long as the container does not depart from the advantages of the present invention, including secure attachment to a motorcycle surface.

In a yet another embodiment, the container has length and breadth that are less than the corresponding dimensions of the trunk so that the container can be fitted/accommodated fully within the trunk. In this case, the height of the container is dependent on the height of the trunk sides as well as the height of the sides of the trunk top/lid such that when the trunk top/lid is closed over the trunk the underlying container does not hinder convenient closure of the trunk top/lid onto the trunk.

According to another aspect of the present invention, a first container is attached to the trunk bra and therefore the underlying trunk top/lid while a second container is attached on top of the first container thereby enabling attachment of multiple (in this case two) containers onto the trunk top/lid.

In another embodiment, the present invention is directed toward a container attachment system for removably attaching a first container, having a top and a bottom, to a second container, wherein the second container has an interior and a lid with an exterior top surface, comprising a) a surface cover for covering the exterior top surface of said lid wherein said surface cover comprises a main body and a plurality of edge portions extending from said main body, b) a first container fastening means comprising a first part and a second part to which the first part mates, wherein said first part is positioned on at least one of said main body or said edge portions and wherein said second part is positioned on the first container, and c) a second container fastening means comprising a first part and a second part to which the first part mates, wherein said first part is positioned on the edge portions and wherein said second part is positioned in the interior of said second container. Optionally, the first part of the first container fastening means comprises at least one buckle, such as but not limited to a rectangular D-ring, and the second part of the first container fastening means comprises at least one strap, which is positioned proximate to the bottom of the first container. Optionally, the strap comprises Velcro and a pull stop. Optionally, at least two buckles, such as a rectangular D-ring, are positioned on at least one of the edge portions. Optionally, at least one buckle, such as a rectangular D-ring, is positioned on each of the edge portions. Optionally, the first part of the second container fastening means comprises Velcro and the second part of the second container fastening means comprises straps that mate with Velcro. Optionally, at least one of the edge portions comprises a non-stretch reinforcing material.

In another embodiment, the present invention is directed to a container system, comprising a) a surface cover for covering an exterior top surface of a lid of a first container wherein the surface cover comprises a main body, a plurality of edge portions extending from the main body, and a first part of a second container fastening means, b) a second container comprising a top, a bottom, and a second part of the second container fastening means, wherein the second part is capable of attaching to the first part, and c) a first container fastening means comprising a first part, wherein the first part is positioned on the edge portions of the surface cover and wherein the first part is capable of attaching to a second part of the first container fastening means positioned in an interior of the first container.

Optionally, the first part of the second container fastening means comprises at least one buckle, such as but not limited to a rectangular D-ring and the second part of the second container fastening means comprises at least one strap. Optionally, the strap is positioned proximate to the bottom of said second container, comprises Velcro, and comprises a stop (such as a pull stop). Optionally, the first part of the first container fastening means comprises Velcro, the second part of the first container fastening means comprises straps that mate with Velcro, and the bottom of the second container has a surface with a contour that is complementary to a contour on the exterior top surface of the lid of the first container.

### BRIEF DESCRIPTION OF THE DRAWINGS

These and other features and advantages of the present invention will be appreciated, as they become better understood by reference to the following Detailed Description when considered in connection with the accompanying drawings, wherein:

FIG. 1a shows a trunk bra in accordance with one embodiment of the present invention, further illustrating the fastening system;

FIG. 1b depicts the underside of the trunk top/lid when the trunk top/lid is in an open position, further illustrating the underside portions of the trunk bra used to fasten the bra to the underside of the trunk lid;

FIG. 1c is a top view of the bra of the present invention attached to the top portion of the trunk;

FIG. 2a illustrates one embodiment of a container attached to the trunk bra, further showing at least one non-stretch reinforcement sewn into the inside portion of the bra;

FIG. 2b illustrates one embodiment of Velcro strap and buckle used to attach the container to trunk bra, further showing a pull stop sewn into the strap for reinforcement;

FIG. 2c illustrates the contour/curvature shape of the bottom surface of a container, for optimal attachment to the bra that is attached to the trunk top;

FIG. 3a illustrates a second embodiment of a container attached to the trunk bra, where such container may also be used inside the trunk;

FIG. 3b illustrates a second embodiment of a container attached to a rack that is fixedly attached to the top of the trunk;

FIG. 3c illustrates a second embodiment of a container, whereby the container is fitted inside the trunk;

FIG. 4a is a top view of one embodiment of a trunk top/lid further illustrating the contours of the top surface;

FIG. 4b is a side view of one embodiment of a trunk top/lid further illustrating a curvature/contour on the top surface;

FIG. 5 is an illustration of a conventional motorcycle trunk that may be used with the bra and container of the present invention;

FIG. 6 is a flow diagram describing steps for attaching the bra of the present invention to trunk top/lid; and

FIG. 7 is an illustration of an alternative embodiment of the present invention, showing at least one strap that is employed to fasten the containers of the present invention to a trunk surface.

### DETAILED DESCRIPTION OF THE INVENTION

Various modifications to the preferred embodiment, disclosed herein, will be readily apparent to those of ordinary skill in the art and the disclosure set forth herein may be applicable to other embodiments and applications without departing from the spirit and scope of the present invention and the claims hereto appended. Reference will now be made in detail to specific embodiments of the invention. Language used in this specification should not be interpreted as a general disavowal of any one specific embodiment or used to limit the claims beyond the meaning of the terms used therein.

The present invention provides a removable a fastening system that is securely attachable to the smooth top surface of a motorcycle trunk, functions as a protective covering to the top surface of the trunk, and enables additional luggage to be securely carried on the smooth trunk top. In one embodiment, the fastening system of the present invention comprises a trunk bra.

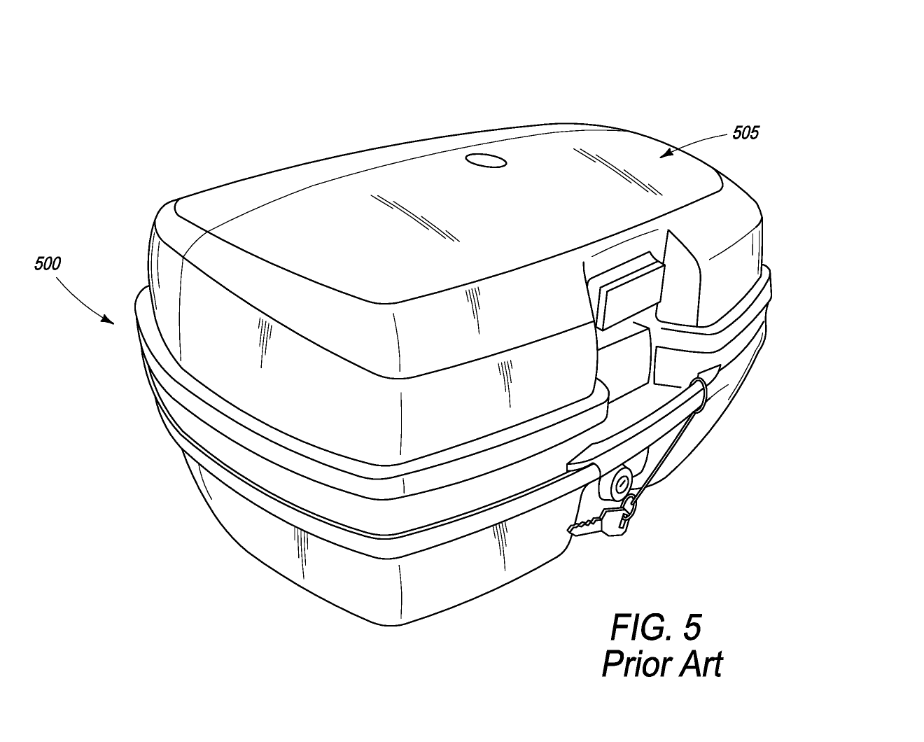

FIG. 5 is an illustration of a conventional motorcycle trunk 500 that may be used with the bra and container of the present invention. Conventional motorcycle trunk 500 is typically used by bikers to accommodate luggage while riding. The present invention may also be used with such configuration and will be described in greater detail below. Trunk 500 has a top or lid 505 that can be raised or opened to put luggage or store other items inside trunk 500. The lid or top 505 may be hinged to the trunk 500 at one edge. Bikers are often faced with a challenge of securely and aesthetically carrying luggage in addition to that which is already accommodated in the trunk 500 to full capacity.

As shown in FIG. 5, the trunk top or lid 505 surface is contoured, smooth and/or devoid of protusions which can be used to attach, connect, or otherwise secure additional luggage. Use of racks mounted on trunk tops, to which the additional luggage is then fastened, is known in prior art. While such racks solve the purpose, they are not highly desirable to biking enthusiasts due to low aesthetic value and because they cause permanent damage to the trunk top or surface to which the rack is attached, since it has to be bolted in with holes drilled into the top trunk surface. Thus, according to an aspect of the present invention, additional luggage is fastened to trunk top without the use of a rack.

According to one aspect of the present invention, the trunk top to which additional luggage is fastened has a substantially smooth top surface. As used herein, the term ‘smooth’ describes any trunk surface, including the trunk lid or top, which is devoid of protrusions, extensions, racks, members, or hooks which could be used to securely fasten additional luggage thereon. A smooth trunk surface may be contoured, straight, or curved. In one embodiment, the surface of the trunk top/lid is mostly linear and not contoured or curved. In another embodiment, the surface of the trunk top/lid is contoured.

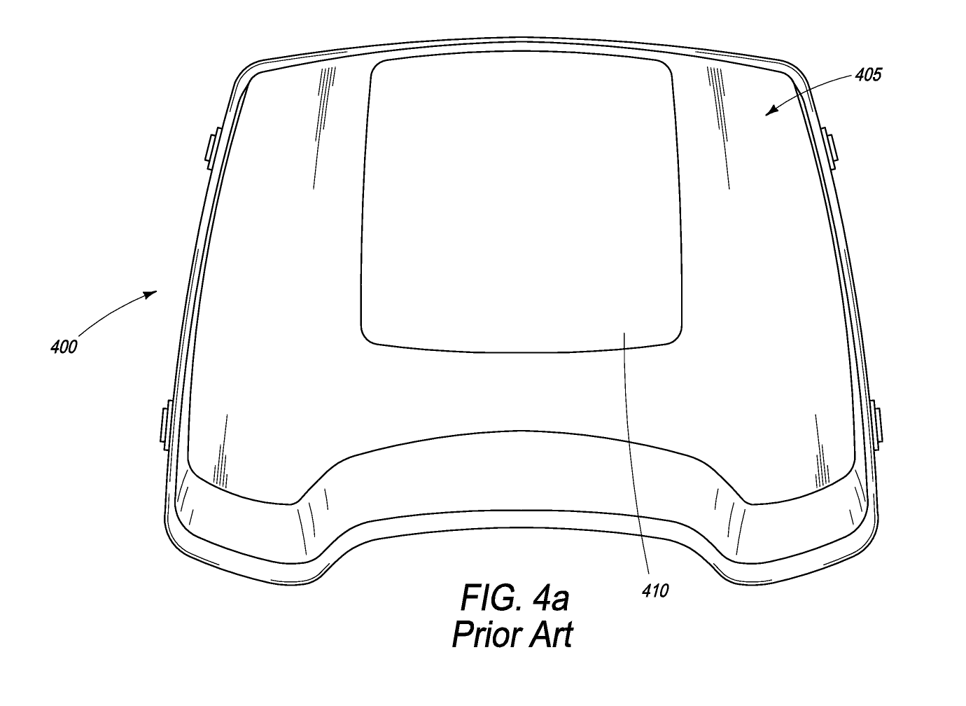

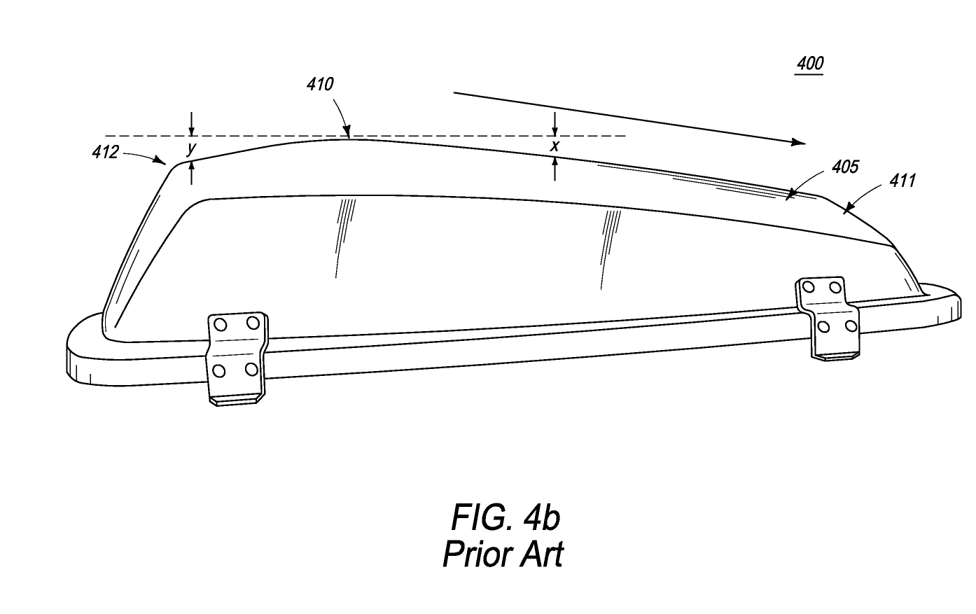

FIG. 4a is a top view of one embodiment of a trunk top/lid 400 further illustrating the contours of the top surface 405. Depression or channel 410 on surface 405 shows that while there could be such ornamental design leading to a negligibly uneven surface, it still does not in any way aid holding of additional luggage on the surface 405 and therefore such uneven surface still lies within the meaning of the term ‘smooth’ for the purposes of the present invention.

FIG. 4b is a side view of one embodiment of a trunk top/lid 400 further illustrating a curvature/contour on the top surface 405. Here, surface 405 is contoured. Relative to peak position 410, each trunk end 411, 412 is sloped downward. This contour, which can be comprised of any slope, may provide an ornamental design, but, again, does not provide any mechanism to securely attach additional luggage on the surface 405. It should be noted herein that the at least one container that may be used with the present invention is optionally designed to fit the contouring of the top surface of the trunk top/lid.

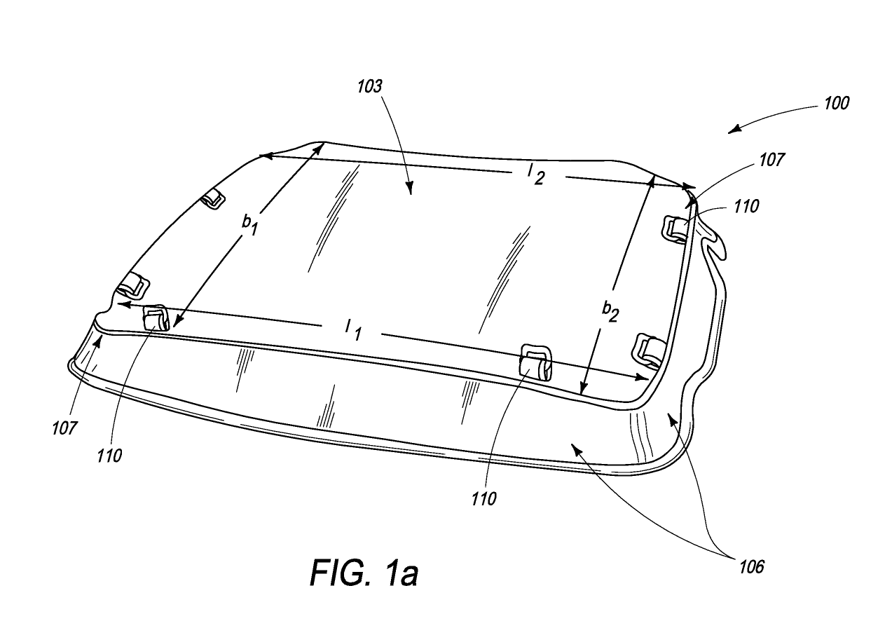

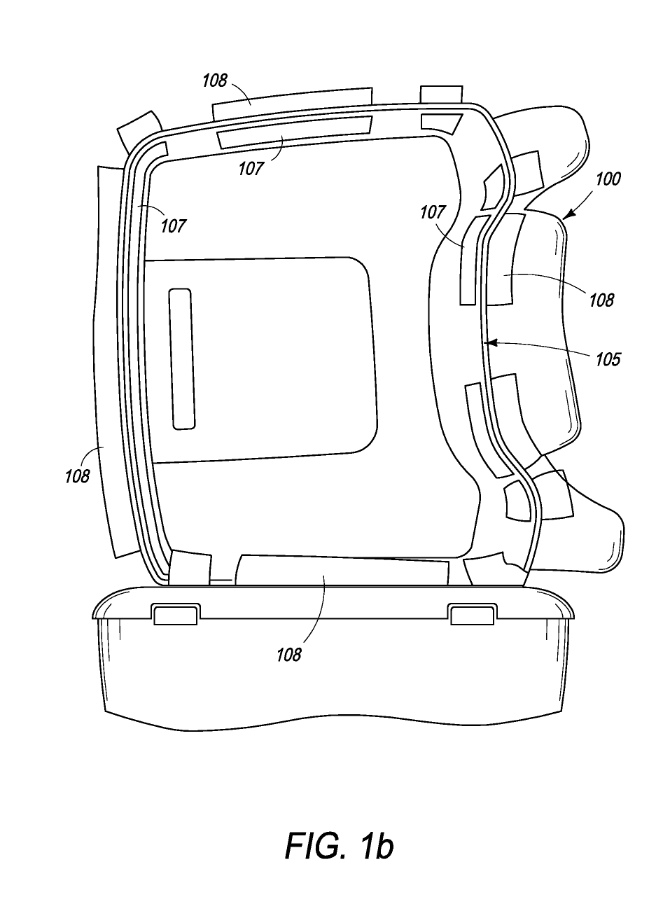

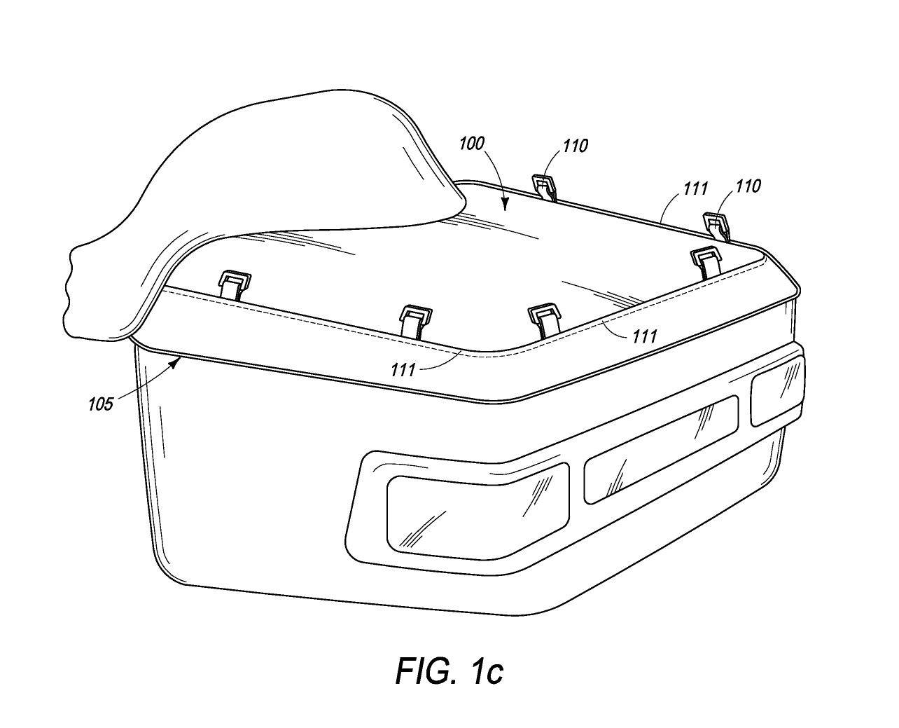

FIG. 1a shows a trunk bra in accordance with one embodiment of the present invention, further illustrating the fastening system. In one embodiment, trunk bra 100 comprises a first portion 103 of fabric/material that covers the ‘smooth’ top surface of a motorcycle trunk top/lid; a second portion of fabric/material in the form of flaps 106 that wrap around the four external sides or edges of the motorcycle trunk top/lid; and a plurality of fastening aids, such as buckles or D-rings 110, along edges that enable attachment of additional luggage onto the bra 100. Each side of the first portion 103 is connected to a flap 106 by an edge or seam 107, that is optionally reinforced.

First portion 103 is quadrangular and substantially conforms to the shape of the trunk top/lid to enable a tight fit when covered thereon. In one embodiment, the first portion 103 has dimensions l₁, l₂, b₁, b₂. In one embodiment, l₁ is not equal to l₂ and b₁ is also not equal to b₂. In another embodiment, l₁ is equal to l₂ while b₁ is not equal to b₂. In another embodiment, l₁ is not equal to l₂ while b₁ is equal to b₂. In yet another embodiment, l₁ is equal to l₂ and b₁ is equal to b₂. One of ordinary skill in the art would appreciate that the relative sizes of l₁, l₂, b₁, and b₂ are dependent upon the size of the trunk and can vary based upon the application, yet still be within the scope of the present invention. One of ordinary skill in the art should also appreciate that the first portion 103 may be any shape, including circular, polygonal, oval, etc. and, correspondingly, may have one circular or oval side or any number of sides in accordance with the shape of the first portion. The intent is to provide a material/fabric cover to the trunk lid and extending down, over the lid sides, to the point where the lid hinges open and exposes the interior of the trunk.

The trunk bra 100 of the present invention is manufactured using material that can withstand the elements and yet allows for an aesthetic appearance. In addition, it is preferred that the material used has very little stretch and ensures a tight fit throughout. In one embodiment, the exterior or top surface of the bra 100 and flap edges 106 are made of PVC (leather look) or leather while the interior or bottom surface (that is the surface that touches the paint on the trunk top) has felt, thermoform or fleece glued or laminated thereto. In other embodiments, various materials may be used such as, but not limited to PE, a woven fabric (nylon, polyester, etc.).

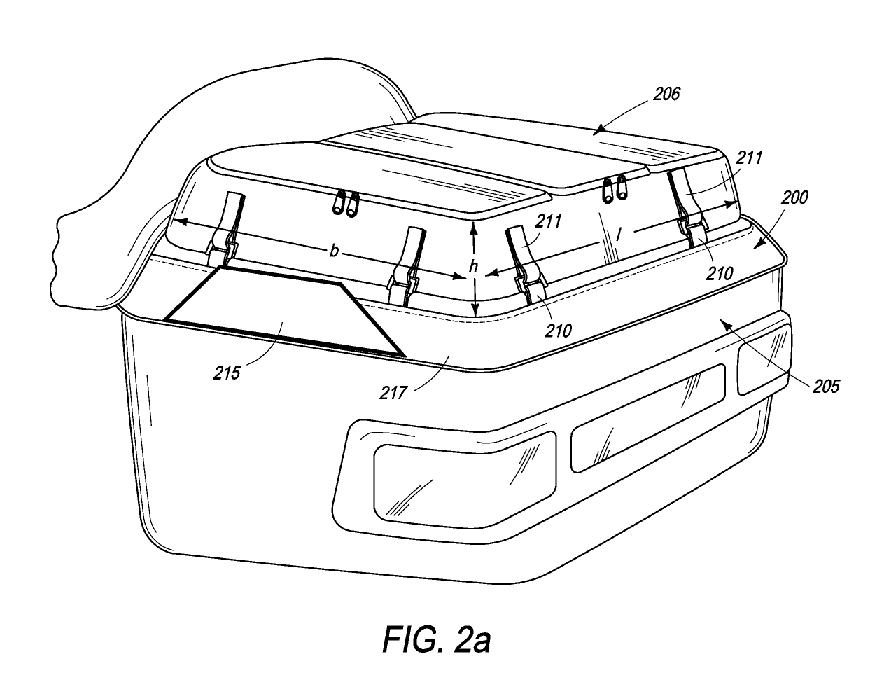

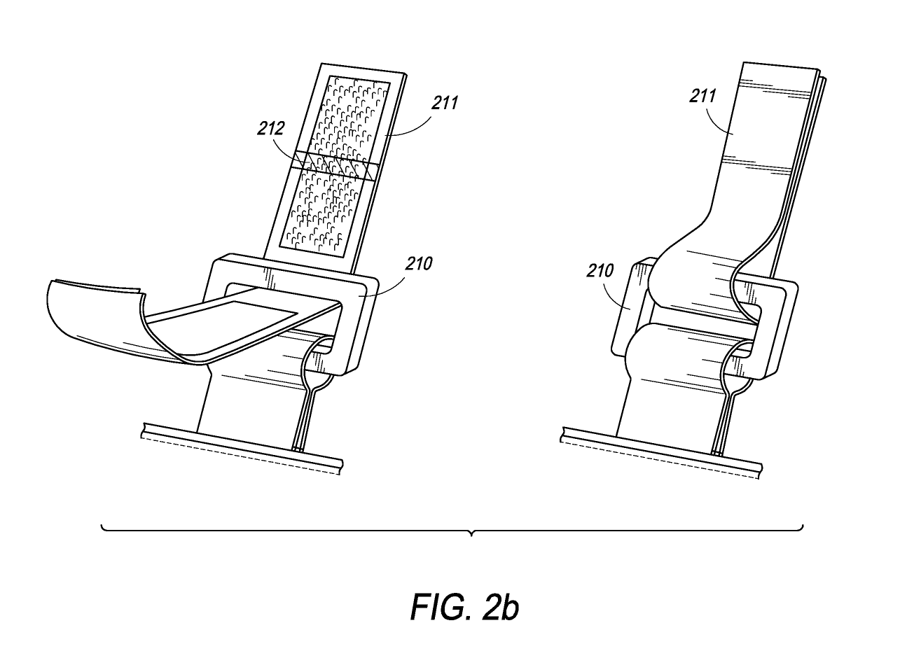

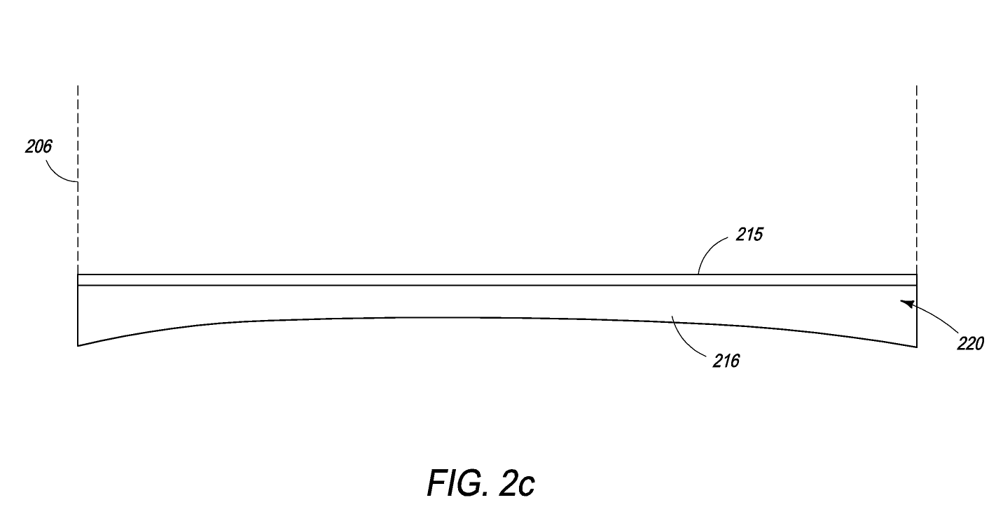

In another embodiment, flap edges 106 further comprises a non-stretch fabric sewn into the inner surface of the flap edge, as shown in FIG. 2a as 215. The non-stretch fabric is employed to eliminate any vertical stretch of the flap edge 106 or the material that comprises the bra. In addition, the non-stretch lining also serves the purpose of reinforcing the straps and rectangular D-rings, shown in FIG. 1c as 111 so that they do not stretch or tear when tightened.

To attach the bra to the surface of the trunk, flaps 106 have portions 108 (not shown in FIG. 1a, shown in FIG. 1b) that extend downward, past the edge of the trunk lid, and therefore have widths that, at least at certain points, are greater than the side of the trunk lid.

It should be appreciated that this additional material, shown as 108 in FIG. 1b, can be of several configurations, including but not limited to continuous around all flaps; discontinuous and, therefore, only on portions of flaps; integrally formed with the flaps; or removably attached to the flaps by an attachment means, such as sewing, zippers, buttons, snaps, Velcro, or other known attachment means. Regardless, the additional material serves to extend the width of the bra beyond and below the bottom edge of the trunk lid so that it can be securely fastened to the trunk lid. In one embodiment, the additional flap lengths 108, shown in FIG. 1b, comprise a woven fabric which still allows for the trunk lid to be securely shut. Thus, it is wedged in between the trunk lid and main cargo cavity such that it does not interfere with the lid “seal”, and thus, the rubber weather ring that is conventionally positioned between the trunk lid and main cargo compartment. In one embodiment a rip-stop 70 denier or 90 denier nylon fabric is used to attache the Velcro to the bra. The thin rip-stop is strong and does not stretch, thus helping the first portion 103 to rest flush or tight against the top of the lid so luggage can be attached securely, without slippage or sliding around. Essentially, the bra becomes so tight to the lid that it becomes part of as well as integral to the lid and secure enough for luggage attachment.

Referring now to FIG. 1b, the trunk top/lid 105 is shown from the inside with the trunk top 105 opened or pulled upward. The flap edging 108, which is positioned on the internal surface of the trunk lid, as discussed above, extends past the trunk lid and therefore, can be turned inward, through the underside of the trunk top 105, and be secured to a surface in the interior of the trunk lid 105. It should be appreciated that there are numerous ways to secure the additional material 108 to the interior surface of the trunk lid 105. In one embodiment, the additional material 108 comprises Velcro on its inner surface and the interior surface of the trunk lid comprises strips of material capable of mating with Velcro strips 107, which in one embodiment, is a Velcro mating surface. The additional material 108 is then secured to the Velcro strips 107 by curling the additional material 108 around the underside of the trunk lid and pressing the additional material 108 firmly on to the corresponding Velcro strip 107.

In another embodiment, the additional material 108 comprises a plurality of holes and the interior surface of the trunk lid 105 comprises physical hooks (not shown). The additional material 108 is then secured to the interior of the trunk lid by curling the additional material 108 around the underside of the trunk lid and passing the hooks on the interior surface through the holes of the additional material 108.

In another embodiment, the additional material 108 comprises edging having a first portion of a zipper and the interior surface of the trunk lid 105 comprises a second mating portion of a zipper. The additional material 108 is then secured to the portions 107 by curling the additional material 108 around the underside of the trunk lid and zipping the additional material to the interior surface.

In another embodiment, the additional material 108 comprises a plurality of buttons and the interior surface of the trunk lid 105 comprises physical holes. The additional material 108 is then secured to the interior of the trunk lid by curling the additional material 108 around the underside of the trunk lid and passing the buttons on the additional material 108 through the holes of the interior surface.

In another embodiment, the additional material 108 comprises the first portion of a plurality of snaps and the interior surface of the trunk lid 105 comprises the mating portion of a plurality of snaps. The additional material 108 is then secured to the interior of the trunk lid by curling the additional material 108 around the underside of the trunk lid and snapping the first portion of the snaps on the additional material to the mating portion of the snaps on the interior surface.

In each of the aforementioned embodiments, the bra, by virtue of its connection to the additional material, is securely positioned on the trunk lid surface through the various mechanisms for attaching the additional material to the interior of the lid attachment means, as discussed above and, additionally, because closing the trunk top 105 on top of the additional material 108, or flap extension, of the bra 100 further helps secure the bra 100 in place.

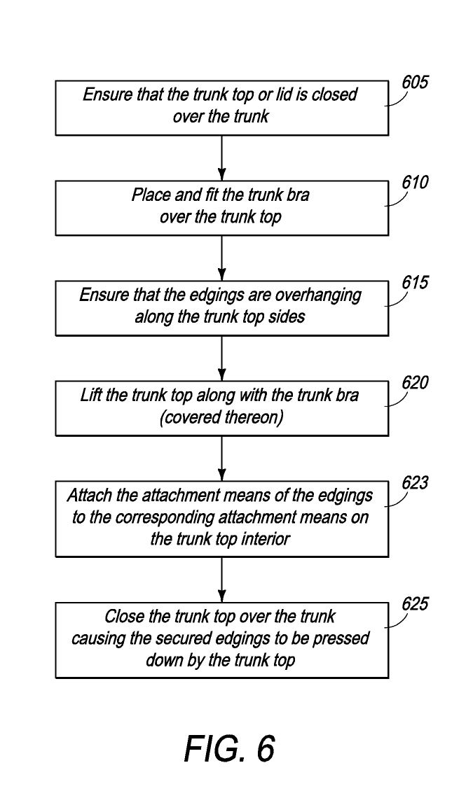

FIG. 6 is a flow diagram describing example steps for attaching the trunk bra to the trunk top. Referring now to FIGS. 1b and 6 simultaneously, at step 605 it is ensured that the trunk top/lid 105 is in a closed position covering the trunk. At step 610 the trunk bra 100 is placed on the ‘smooth’ rackless surface of the trunk top/lid 105 and adjusted to ensure that it sufficiently fits the shape and dimensions of the trunk top 105. It should be appreciated that the bra 100 is comprised of a material such that it has relatively little stretch to it, but is still flexible enough for improved fit on various surfaces. In one embodiment, the bra is stretched tight and fits the trunk cover like a skin, such that it does not wrinkle or stretch and such that a container or bag can be securely attached to the bra without movement.

At step 615, the flap edgings 106 of the bra 100 are overhanging along the sides of the trunk top 105. At step 620 the trunk top/lid 105 with the bra 100 on, is lifted/pulled-up and the flap edgings 108 are pulled around and through the underside of the trunk top 105. At step 623, the attachment means on the flap edgings 108, is then secured to the corresponding attachment means on the inner edges of the trunk top 105. Thereafter, at step 625, the trunk top 105 is closed over the trunk thereby pressing the edgings 108 and therefore further securing the bra 100 to the trunk top 105.

FIG. 1c is a top view of the trunk bra 100 of the present invention when securely attached to the top portion of the trunk. In one embodiment, the trunk bra 100 comprises a plurality of straps 110 sewn along the edges 111 at the top side of the bra 100. Straps 110 may further comprise buckles, D-rings, or other attachment rings to allow additional luggage to be secured to the bra 100 and therefore the trunk top 105. While any number of straps with buckles or rectangular D-rings 110 can be used, one embodiment of the bra comprises at least six buckles—a pair each along the front three edges 111 of the bra 100, while the edge facing and abutting the bike back-rest is devoid of such buckles. Persons of ordinary skill in the art should appreciate that the placement of the buckles and therefore the attachment points are chosen to minimize air gap between trunk bra 100 and additional luggage attached thereon and allow for convenient but strong securing without compromising the integrity of the attachments.

According to another aspect of the present invention a container is used as additional luggage to be attached to the trunk top and thus trunk bra. In one embodiment, the container is a bag made of fabric such as leather, PVC, toughened nylon or any other pliable, flexible yet wear and water resistant material evident to persons of ordinary skill in the art.

FIG. 2a illustrates one embodiment of a container attached to the trunk bra, further showing at least one non-stretch reinforcement sewn into the inside portion of the bra. FIG. 2a shows container 206, in accordance with one embodiment, that accommodates additional pieces of luggage and is attached to top of the trunk 205 by means of trunk bra 200. In one embodiment container 206 has a substantially rectangular bottom surface with a length ‘l’ and breadth ‘b’ that are slightly less than the corresponding dimensions of the trunk bra 200. This ensures that the bottom of the container 206 does not protrude beyond or overlap the bra buckles 210 allowing for convenient strapping of the container 206 onto the trunk bra 200. The height ‘h’ of the container 206 is dependent on at least a) the amount and volume of additional luggage to be accommodated inside the container 206, and/or b) the need to keep the center of gravity of the combined trunk 205 and container 206 composite lower for better stability particularly when the motorcycle takes a sharp turn. With high ‘h’, during a sharp turn of the motorcycle, the shearing force on the bra buckles 210 (to which the container 206 is fastened) could be high resulting in tear or stretching at the points on the bra 200 where the buckles 210 are attached.

As mentioned above, FIG. 2a illustrates at least one non-stretch fabric reinforcement strip 215 to prevent the trunk bra from stretching. It should be noted herein that the fabric reinforcement may be comprised of one piece or may comprise discrete pieces of fabric placed along the inside of each flap edge 217.

In one embodiment the container 206 comprises a plurality of Velcro hook-and-loop straps 211 along the side walls. Straps 211 correspond to the bra buckles or rectangular D-rings 210, thereby serving as a container fastening means, and in one embodiment are placed at a distance away from the container edges so that, when attached to the underlying bra 200, they do not cause the bra 200 to excessively stretch or place excessive strain on the buckle.

FIG. 2b illustrates one embodiment of Velcro strap and buckle used to attach the container to trunk bra, further showing a pull stop sewn into the strap for reinforcement. Now referring to FIG. 2b, the Velcro straps 211 are made to pass through the corresponding bra buckles or rectangular D-rings 210 to securely attach the container 206 to the bra 200 and therefore to the top of the trunk 205. In one embodiment, a pull stop 212 is sewn into each strap 211 at an optimal position to prevent container 206 and trunk bra 200 distortion or stretching. Without stop 212, a person could pull the strap up, through the buckle, and cause excessive strain on the buckle. The edge of the trunk bra 200 and/or container 206 near the buckle 210 may distort, stretch, or tear if over-tightened. Pull-stop 212 therefore prevents over-tightening and also is positioned such that the bag is secured to the bra tightly enough to prevent movement. Thus, the placement of the pull-stop is carefully designed to satisfy these competing requirements. Stop 212 can be any physical blockage including a piece of plastic or other material that prevents the strap from passing through the buckle hole.

The present invention envisages use of a plurality of fasteners as alternate means of attachment. Thus, while one embodiment uses Velcro pull through type straps as described with reference to FIG. 2b, alternate embodiments use D-rings, clip links, easy/side release fasteners (such as those found on animal collars), zippers along the edging, different types of buckles, cords (provided with a reinforced grommet), buttons, snaps, or any other fasteners as would be evident to persons of ordinary skill in the art. In each case the bra would have a first portion of the container fastening means while the container had the second, corresponding portion of the container fastening means. It should further be appreciated that the present invention encompasses combinations of fastening means onto a single bra or container and further encompasses any placement or configuration of the fastening means on either the bra or container, including, for example, switching the buckles from the bra to the container and the Velcro straps from the container to the bra.

Referring again to FIG. 2a, in one embodiment the bottom of the container 206 curves to the top or lid of the trunk 205 to minimize air gap between trunk bra 200 and container 206 and allow for more secure fitting. FIG. 4b shows side view of an embodiment of trunk top/lid 400 depicting curvatures or contours on its top surface 405. In one embodiment the top surface 405 has a downward slope of about ‘x’ degrees, from its top most point 410, in the direction of the arrow. Similarly, there is a downward slope of about ‘y’ degrees from the top most point 410 on the trunk top surface 405 towards each edge. In one embodiment ‘x’ is about 20 degrees and ‘y’ is about 3 to 4 degrees. Thus, the bottom surface of the container 206 is also contoured to closely conform to the curvatures ‘x’ and ‘y’ of the trunk top to minimize air gap between the container 206 and the bra 200 and thus reduce the tension on the straps 211. In one embodiment the bottom of the container 206 is made of thick stiffened or reinforced fabric that is shaped into a permanent curvature or contour as that of the trunk top. In another embodiment the bottom of the container 206 is not shaped or contoured but being made of sufficiently flexible and pliable fabric, closely takes on the shape of the trunk top as the weight of the contents of the loaded container 206 press the bottom onto the trunk top.

FIG. 2c illustrates the contour/curvature shape of the bottom surface of a container, for optimal attachment to the bra that is attached to the trunk top. Thus, in another embodiment, as shown in FIG. 2c, an additional unit, such as a sole reinforcement 220, is attached to an otherwise flat bottom 215 of the container 206 while the bottom surface 216 of the sole 210 in turn carries a preformed contour or curve that closely conforms to the contour of the trunk top/lid. In one embodiment sole 220 is made of plastic, stiffened leather or any other material as would be evident to persons of ordinary skill in the art.

While in the current embodiment the container 206 and trunk bra 200 are described as two discrete items that can be attached to each other, in an alternate embodiment the container 206 and the trunk bra 200 are formed as a single integrated article such that a user only needs to attach the trunk bra 200 to the trunk top thereby essentially securing the integrated container 206 to the trunk top as well.

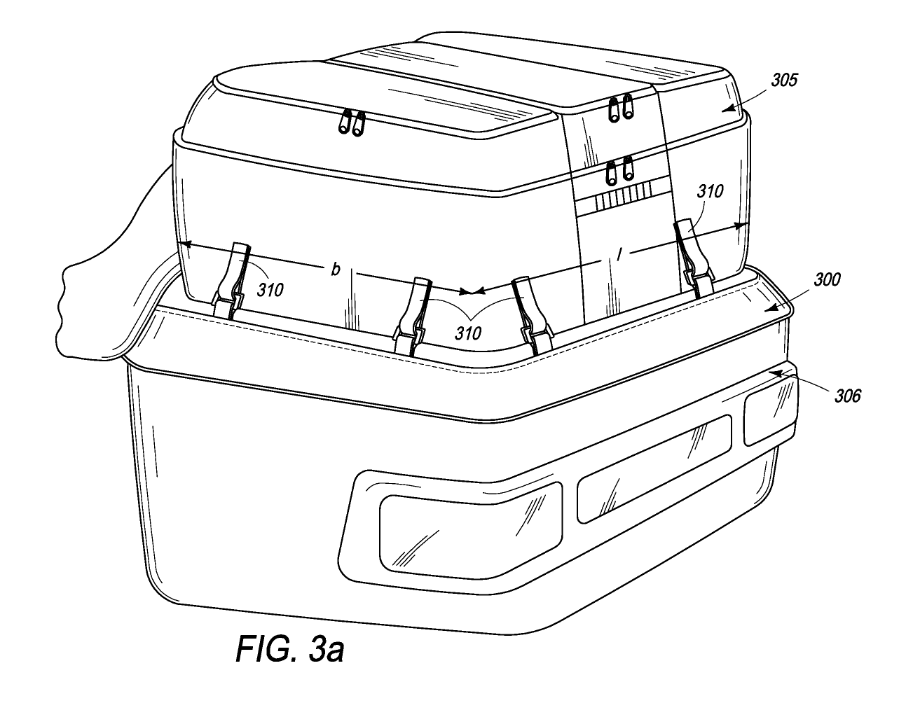

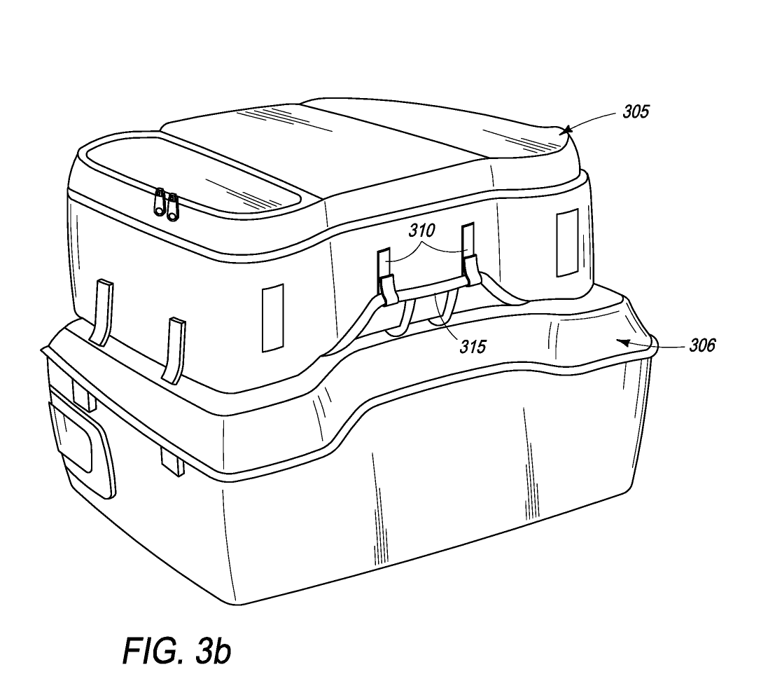

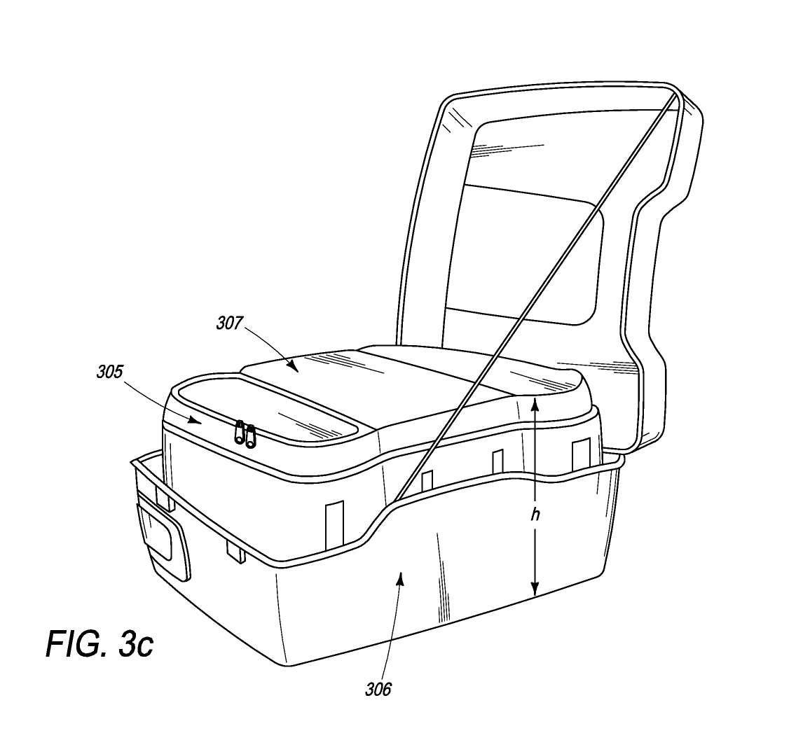

FIG. 3a illustrates a second embodiment of a container attached to the trunk bra, where such container may also be used inside the trunk. It should be noted herein that the container/bootcase shown in FIGS. 3a, 3b, and 3c, is larger than the container shown in FIGS. 2a, 2b, and 2c, and is designed such that it can optionally be placed inside the trunk when extra space is not needed. It should also be noted that the smaller container of FIGS. 2a, 2b, and 2c are not designed to be placed inside the trunk.

Referring now to FIG. 3a, container 305 provides an additional piece of luggage for attachment to the trunk bra 300 and therefore the ‘smooth’ top of a rackless trunk 306. The container 305 is attached to the trunk bra 300, in one embodiment, by means of buckles and Velcro straps 310 (buckles being on the bra 300 and the Velcro straps being on the container 305). In one embodiment, the container 305 is essentially an enlarged container 200 of FIG. 2a that has expanded to accommodate more luggage articles. In another embodiment, the container 305 is a discrete piece of luggage which is much larger than the container 200 of FIG. 2a.

In one embodiment container 305 has a substantially rectangular bottom with a length ‘l’ and breadth ‘b’ that is contoured to conform closely to the curvature of the trunk top, as described earlier with reference to FIG. 4b. In one embodiment the dimensions ‘l’ and ‘b’ are such that these are slightly less than the corresponding length and breadth of the trunk bra 300 so that no portion of the container bottom stretches out of or overlaps the edges of the trunk bra 300. This allows for easier and more secured fastening of the container 305 to the buckles along the edges of the trunk bra 300.

In another embodiment the dimensions ‘l’ and ‘b’ are less than the corresponding length and breadth of the trunk 306 so that the container 305 can also be fitted or accommodated inside trunk 306, as shown in FIG. 3c. The top surface 307 of the container 305 is contoured, in one embodiment, in line with the contour/curvature of the trunk lid (such as the contour or curvature slopes ‘x’ and ‘y’ of the trunk top 400 of FIG. 4b) for a tight fit within the trunk 306 once the lid is closed. Also, in this embodiment, the height ‘h’ of the container 305 is contingent partly on the height of the trunk 306 and partly on the height of the sides of the lid of the trunk, so that when the container 305 is placed inside the trunk 306, the trunk top or lid can be closed without hindrance from the container 305. In yet another embodiment the dimensions ‘l’ and ‘b’ are slightly less than the corresponding dimensions of a rack 315 that is attached on top of the trunk 306, as shown in FIG. 3b. Velcro straps 310, sewn along the lower sides of the container 305, are used to secure the container 305 around the tubular luggage rack rails 315.

Persons of ordinary skill in the art should note that while in the examples above the containers 206 and 305 of FIGS. 2a and 3a respectively are attachable to the trunk bra, of the present invention, separately; In this example the container 206 additionally comprises a plurality of buckles at the top edges as well. The corresponding Velcro straps on the lower sides of the container 305 are then passed through the bra buckles to tie-down the container 305 on top of the container 206. In another embodiment, the container 305 is attached to the trunk bra as shown in FIG. 3a and then further the container 206 is attached on top of the container 305. In this example the container 305 additionally comprises a plurality of buckles at the top edges. The corresponding Velcro straps on the lower sides of the container 206 are then passed through the buckles of container 305 to tie down container 206 on top of the container 305. Thus, a plurality of containers/bags/luggage can be attached on top of one another and therefore to the top of the motorcycle trunk.

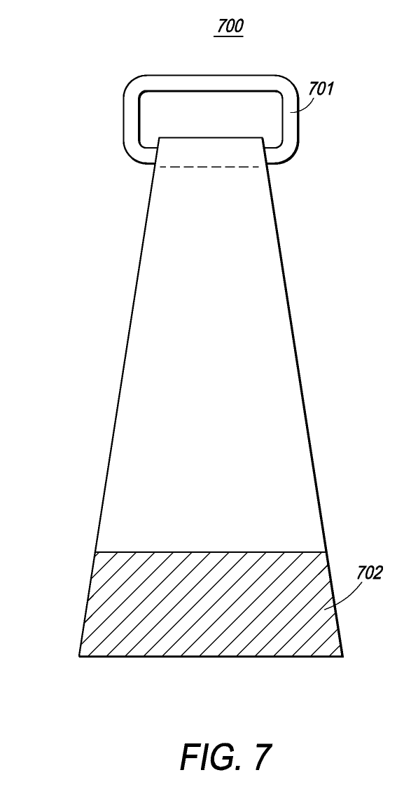

In an alternate embodiment of the present invention, the trunk bra is minimized such that it comprises straps that can be securely attached to the underside of the trunk lid using Velcro, and brought upwards to the external top of the trunk lid. Thus, there is no top surface material, but rather, straps that are closed in between the lid and main cargo of the trunk, near the weatherized rubber seal. FIG. 7 is an illustration of an alternative embodiment of the present invention, showing at least one strap 700 that is employed to fasten the containers of the present invention to a trunk surface. In one embodiment, a minimum of six straps 700 is employed. In one embodiment, the straps 700 are positioned throughout the inner surface (not shown) of the trunk cover (not shown) and secured to the inner surface of the trunk cover using area 702, which is an adhesive material such as Velcro®. In addition, the straps are, in one embodiment, fitted with rectangular D-rings 701 that can be used to fasten a cargo bag to the trunk without the bra surface covering.

It should be noted herein that while exemplary dimensions are provided for the container attachment system, such a system can be employed to conform to any smooth surface on a motorcycle, including but not limited to the top surface of a saddle bag. Thus, a bra and container can also be attached to a side saddle. In addition, straps may be provided without a bra, on the side saddle for container attachment.

While there has been illustrated and described what is at present considered to be a preferred embodiment of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiment disclosed as the best mode contemplated for carrying out the invention, but that the invention will include all embodiments falling within the scope of the appended claims.

We claim:

1. A container attachment system for removably attaching a first container, having a top and a bottom, to a second container, wherein the second container has an interior and a lid with an exterior top surface, comprising
a. a surface cover for covering the exterior top surface of said lid wherein said surface cover comprises a main body and a plurality of edge portions extending from said main body;
b. a first container fastening means comprising a first part and a second part to which the first part mates, wherein said first part is positioned on at least one of said main body or said edge portions and wherein said second part is positioned on the first container; and
c. a second container fastening means comprising a first part and a second part to which the first part mates, wherein said first part is positioned on the edge portions and wherein said second part is positioned in the interior of said second container.

2. The container attachment system of claim 1 wherein said first part of the first container fastening means comprises at least one buckle.

3. The container attachment system of claim 2 wherein said second part of the first container fastening means comprises at least one strap.

4. The container attachment system of claim 3 wherein said strap is positioned proximate to the bottom of said first container.

5. The container attachment system of claim 3 wherein said strap comprises Velcro.

6. The container attachment system of claim 3 wherein said strap comprises a stop.

7. The container attachment system of claim 2 wherein at least two buckles are positioned on at least one of said edge portions.

8. The container attachment system of claim 2 wherein at least one buckle is positioned on each of said edge portions.

9. The container attachment system of claim 1 wherein the first part of the second container fastening means comprises Velcro.

10. The container attachment system of claim 2 wherein the second part of the second container fastening means comprises straps that mate with Velcro.

11. The container attachment system of claim 1 wherein at least one of said edge portions comprises a non-stretch reinforcing material.

12. A container system, comprising
a. a surface cover for covering an exterior top surface of a lid of a first container wherein said surface cover comprises a main body, a plurality of edge portions extending from said main body, and a first part of a second container fastening means;
b. a second container comprising a top, a bottom, and a second part of the second container fastening means, wherein said second part is capable of attaching to said first part; and
c. a first container fastening means comprising a first part, wherein said first part is positioned on the edge portions of said surface cover and wherein said first part is capable of attaching to a second part of the first container fastening means positioned in an interior of said first container.

13. The container system of claim 12 wherein said first part of the second container fastening means comprises at least one buckle.

14. The container system of claim 13 wherein said second part of the second container fastening means comprises at least one strap.

15. The container system of claim 14 wherein said strap is positioned proximate to the bottom of said second container.

16. The container system of claim 14 wherein said strap comprises Velcro.

17. The container system of claim 14 wherein said strap comprises a stop.

18. The container system of claim 12 wherein the first part of the first container fastening means comprises Velcro.

19. The container system of claim 12 wherein the second part of the first container fastening means comprises straps that mate with Velcro.

20. The container system of claim 12 wherein the bottom of said second container has a surface with a contour that is complementary to a contour on the exterior top surface of the lid of the first container.
